(19) United States
(12) Patent Application Publication
(10) Pub. No.: US 2023/0081280 A1
(43) Pub. Date: Mar. 16, 2023

(54) SYSTEMS AND METHODS FOR TARGETING USERS AND TAILORING INSURANCE POLICIES

(71) Applicant: InsurAware LLC, Atlanta, GA (US)

(72) Inventors: Deepak Gopalakrishnan, Kochi (IN); Shaji Kunjumon, Frederick, MD (US); Rajesh Krishnan, Frederick, MD (US); Patrick Bowen, Atlanta, GA (US)

(21) Appl. No.: 17/942,611

(22) Filed: Sep. 12, 2022

Related U.S. Application Data
(60) Provisional application No. 63/243,031, filed on Sep. 10, 2021.

(51) Int. Cl. G06Q 30/02; G06Q 30/06

(52) U.S. Cl. CPC G06Q 30/0256; G06Q 30/0621

(57) ABSTRACT

Described herein are systems and methods for designing and tailoring insurance solutions and advertising for users. The systems and methods utilize third-party websites and data retrieved therefrom, which is processed via machine learning components of the system. The systems and methods can utilize machine learning and artificial intelligence to generate content and tailor insurance solutions for users.

### CROSS-REFERENCE TO RELATED APPLICATIONS

This application claims priority to U.S. Provisional Application No. 63/243,031 filed on Sep. 10, 2021, the disclosure of which is incorporated herein by reference in its entirety.

### BACKGROUND

The present invention generally relates to systems and methods for identifying potential customers of consumer financial products, such as insurance policies, targeting advertising toward the potential customer to convert them to a consumer, and tailoring the consumer financial product to the consumer.

### SUMMARY

Embodiments herein relate to systems and methods for targeting advertising to potential customers of consumer financial products and tailoring consumer financial products to a consumer. Embodiments herein encompass systems and methods that utilize third-party websites and data retrieved therefrom, which is processed via machine learning components of the system or via machine learning methods. The systems and methods provide an improvement in targeted advertising to users resulting in improved conversion of potential customers to consumers of consumer financial products and better tailoring of said financial products to the end user compared to systems and methods of the prior art.

These and other features, aspects, and advantages of the present embodiments will become understood with reference to the following description, appended claims, and accompanying figures.

### BRIEF DESCRIPTIONS OF THE DRAWINGS

FIG. 1 depicts a system for targeting advertising to potential customers of consumer financial products according to one more embodiments of the disclosure.

FIG. 2 depicts an architecture of a widget hosted on an affiliate site for developing targeting advertising to potential customers of consumer financial products according to one more embodiments of the disclosure.

### DETAILED DESCRIPTION

Insurance policies are typically utilized to provide a predetermined benefit, e.g., a payment, to a specified beneficiary of the insured policy holder and/or to provide financial protection for the policy holder in the event of an unforeseen life event. One such policy is a life insurance policy, wherein a beneficiary, e.g., one or more family members, is provided a predetermined benefit following the death of an insured person. Other life insurance policies can be tailored to provide a predetermined benefit to a different beneficiary. For example, life insurance policies can be designed to pay off the remaining balance on a mortgage loan, a personal loan, and the like. There are many other types of insurance policies that provide protection to a consumer in the event of a different unforeseen life circumstance, including, but not limited to, health insurance, dental insurance, auto insurance, homeowner/renters insurance, accidental death and dismemberment insurance, disability insurance, long-term care insurance, pet insurance, flood insurance, and umbrella insurance.

One problem that impacts the sale of insurance policies to potential customers is the difficulty associated with reaching potential customers and converting these potential customers to consumers of targeted insurance policies. Many individuals may be reluctant to purchase insurance policies, including a life insurance policy, or they may be unaware of the advantages that a particular insurance policy confers. Another problem is the lack of personalization in an insurance policy in accordance with an individual's needs. Accordingly, there is a need for systems and/or methods that provide a more extensive reach to potential customers, effectively convert these potential customers to consumers, and provide these consumers personalized insurance policies, which remain unaddressed by the prior art. The inventors have found that the systems and/or methods relying on targeted advertising that is based on current events and/or leverages a user's online usage data can resolve these problems.

Embodiments disclosed herein can be utilized to identify potential customers of consumer financial products and target advertising toward them. In certain embodiments, targeted advertising can be achieved through the assessment of one or more user's online usage data. For example, if a user is visiting a website discussing the weather and potential harm that could be caused by the weather, such as severe storm damage, or flooding, the embodiments described herein can target advertising to the user for flood insurance.

Embodiments discussed herein may target advertising towards a user by utilizing artificial intelligence (AI) to provide insight on the most likely insurance policies that would both interest and be relevant to said user. In some embodiments, an AI algorithm may assess a user's data usage habits, make estimations about a user's income, assess a user's mood, analyze a user's browser habits, and integrate with and utilize information gathered from other applications utilized by a user. The AI algorithm can utilize the foregoing information and the like, to provide an insurance policy that is better tailored to the user's needs more than would exist if not using the AI systems disclosed herein and data sets described herein. By providing a more user-focused insurance policy, the likelihood of conversion from potential customer to consumer improves.

In certain embodiments, AI, or an AI algorithm, can interface directly with a user, one or more affiliate sites, one or more host sites, and/or a data store to analyze the user's data and provide a basic needs financial calculator. The basic needs financial calculator can be altered by AI, or an AI algorithm, to provide the user with an insurance policy that is best tailored to the user's interests or needs. The alterations performed by the AI, or AI algorithm, are based on inputs, such as current events, a user's usage data, and technological interaction. Prior art systems have not been able to provide this functionality because prior art systems have not interfaced and utilized the aforementioned data coupled with information such as real-time current events to offer a user-focused insurance solution (e.g., the basic needs financial calculator) utilizing AI, or an AI algorithm, in the manner described herein.

Embodiments described herein relate to systems and/or methods for targeted advertising comprising an affiliate site, a host site, a third party data provider, and a data store.

In certain embodiments, an affiliate site can be a third-party website that displays information to a user. In some embodiments, an affiliate site can partner with a host platform and can embed scripts to the host site, wherein the scripts are provided by the host platform.

In some embodiments, a tooling widget exists on the affiliate website. The tooling widget can communicate third-party data and/or embed scripts to the host site and the host site can register first party user data. In certain embodiments, an affiliate website can load external code or instructions, such as JavaScript, that is hosted on a host website. In some embodiments, an affiliate website may receive additional functionality using code or instructions received from a host website, which can be used to track a user and build a customer profile. For example, externally loaded JavaScript can tag a user using an identifier. The JavaScript can also communicate a user's IP address and/or hashed email, user agent, and other meta information that is available to the host site and/or host data store.

In some embodiments, an affiliate site can be integrated with a basic needs financial calculator as a cloud-hosted application through a host site secure channel. In some embodiments, the basic needs financial calculator is integrated as a widget through a host site secure channel. The host site can provide HTML tags to be added to affiliate websites to host a basic needs financial calculator widget in an affiliate website. A user who visits an affiliate website can click on a widget, which can be hosted by the affiliate website or as a cloud-hosted application. The widget can walk the customer through a few questions to recommend the best consumer financial product based on the user's need, utilizing analyses such as rules-based analysis and predictive measures utilizing AI, or an AI algorithm.

In certain embodiments, a host site can comprise host sales tools. In some embodiments, host sales tools can include the software utilized by the host site, for example, Salesforce or Microsoft Dynamics, or may be selected from one or more of customer relationship management, search engine marketing, and the like. In some embodiments, the host sales tools can comprise AI, or an AI algorithm. In certain embodiments, host sales tools can fetch enriched data, such as enriched user profiles, from a host data store. After the host sales tools analyze the enriched data fetched from the host data store, the system can produce a targeted advertisement or online information, which is sent to a user. The targeted advertisement can be selected from the group consisting of an email template sent to a user, a telephone call, video content, audio content, and/or blog articles. In the instance of a blog article, the user can be directed to the blog site based on the AI's assessment of the user demographics.

The AI, or AI algorithm, of the embodiments described herein can analyze user profiles to understand the user's behavior patterns. For example, if a user recently got married and showed some interest in life insurance via the user's online search patterns and internet usage, the AI would develop a rules-based recommendation for the user. The AI, or AI algorithm, can understand the user's data and internet habits and suggest an optimal marketing approach to redirect the user to a particular content aimed specifically at that user, such as an article that talks about “why you should purchase insurance if you are married.” Similarly, if the AI, or AI algorithm, needs more information from the user to derive what kind of consumer financial product the user would be interested in, the AI, or AI algorithm, can develop and send the user a survey with questions that help the AI, or AI algorithm, to further understand the user's interests and target the user's needs based on those interests. A user may also be sent a survey with AI-generated and targeted questions that can be utilized to direct a user to purchase insurance that may suit their needs or fit their life at the moment. The combination of utilizing online user data with real-time, evolving information that exists as a result of a user interfacing with online platforms and the AI utilized by embodiments of the invention can provide technologically improved advertising.

In certain embodiments, a data store can comprise servers, cloud storage, distributed storage locations, and the like.

Certain embodiments may further comprise a third-party data provider. A third-party data provider can request data that is asynchronously transmitted from a host site to the third-party data provider. The third-party data provider may then enrich the data of users utilizing data segments, keywords, and websites visited by the user. In some embodiments, a third-party data provider can match a user's IP address or hashed email with search data possessed by the third-party data provider as a means to identify the user's behavior pattern. The third-party data provider can provide data including data showing the behavior of the user, such as searches the user conducts on search engines and websites, along with the user's interests. A data match can also be conducted using machine-learning algorithms, which can transform the third-party data (e.g., search history, a user's interests) into corresponding keywords. For example, if a user's interests and/or search history include information relating to technology and computers, health, and/or family movies, the machine-learning algorithm could generate keywords such as “computer,” “health,” and “family movies” that will be used with the machine-learning algorithm and AI, or AI algorithm, to develop a rules-based insurance solution tailored to the user.

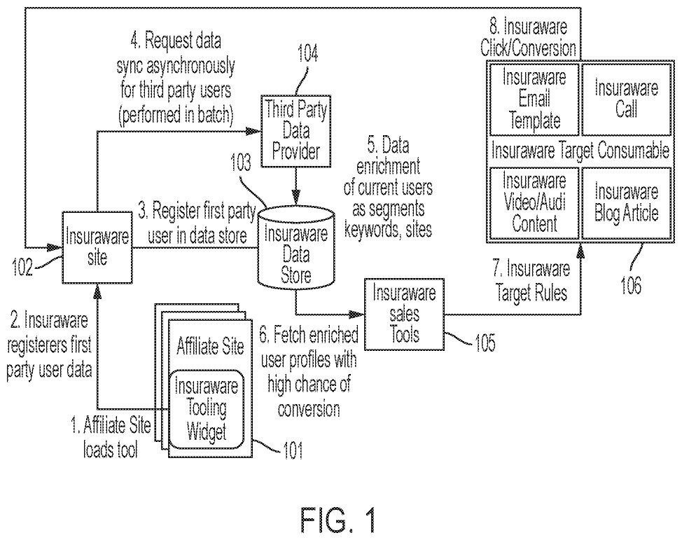

FIG. 1 is a diagram illustrating a system for targeting advertising to potential customers of consumer financial products as described by the disclosed embodiments. FIG. 1 is not intended to be an exhaustive or limited example of a system for targeting advertising to potential customers of consumer financial products to the form disclosed. The diagram was chosen to explain the principles of a method for developing targeting advertising and the practical application and to enable others of ordinary skill in the art to understand the disclosure for various implementation(s) with various modifications and/or any combinations of implementation(s) as are suited to the particular use contemplated, and those which can be practiced by the systems disclosed herein.

1. An affiliate website 101 is visited by a user. The affiliate website 101 comprises a tooling widget that loads external JavaScript that is hosted on a host website 102 (i.e., InsurAware site). The affiliate website 101 may receive additional functionality using this JavaScript loaded from the host website 102. The externally loaded JavaScript is responsible for generating and tagging the user using an identifier (e.g., a user tag) that meets compliance standards. The JavaScript may also pass on user data, such as the user's IP address, user agent, and other available additional metadata, to the host website backend.

2. The host website backend can receive different data from separate affiliate websites. Once data from an affiliate website reaches the host website backend, the data is registered as first-party data on the platform of the host website. The host website platform has a data engineering process service that transforms the registered first party data received from an affiliate website 101 into a normalized form, which is understood by one or more algorithms of the host website platform.

3. The normalized first-party data, which includes information such as the user tag and the metadata acquired from the affiliate website, is then stored onto a host website data store 103.

4. The normalized first-party data is also passed in batch, or individually, to one or more third-party data providers 104, with whom the host website 102 has partnered. The third party data provider 104 generates additional data on the user tag that it received from the host website 102.

5. The third-party data provider 104 enriches the received data from the host website 102 to provide insights on customer behavior to target the customer with specific content, such as segments, keywords, websites visited by the user, and other behavioral information. The third-party data provider 104 feeds this enriched data to the host website data store 103, and the enriched data is stored against the user tag from the normalized first-party data within the host website data store 103.

6. A host website sales platform 105 hosts audience rules that are specified to target specific users and/or user tags. The host website sales platform 105 comprises rules-based targeting, where the rule is a Boolean expression involving any or all of the fields obtained from the affiliate site, the third-party data provider, additional system generated metadata, and the like. An audience rule is a set of instructions to target a group of users based on their demographics and behaviors. An example for a rule is “everyone in New York who has interest in family movies.” The host website creates advertisements based on family movies and targets this group specifically to ensure the systems are sending the users content that the specific users are interested in.

7. The evaluation of targeting rules is periodic and event-driven. A target rule is invoked when certain events occur or periodically, depending on the way the target rule is configured. For example, users may be more willing to purchase or more likely to inquire about purchasing insurance during or following certain events such as large storms, natural disasters, sports events, and other occurrences. These targeted rules comprise an action 106 that is invoked to target the user for conversion. The action 106 includes at least one of an email template being populated and sent to the user, an automated or manual call being made to the user, an automated- or manually- produced article being written on a blog, and video/audio content that is automatically or manually generated by the host website.

8. Any user action, including clicks, conversions, and additional metadata, is then recorded by the host website platform. This data is then used by the host website platform to further enrich the data that it has acquired about the user and/or user tag. The host website platform mines data for insights regarding the count of users, over indexes, and other aggregate measures, which are used by the host website platform in an automated manner (including via AI, or an AI algorithm) to generate content or to better target advertising. The host website platform analyzes the data to identify the user behavior by looking into the user's most-visited websites and categories and to derive the user's interest and develops specific content and graphics targeted toward the user.

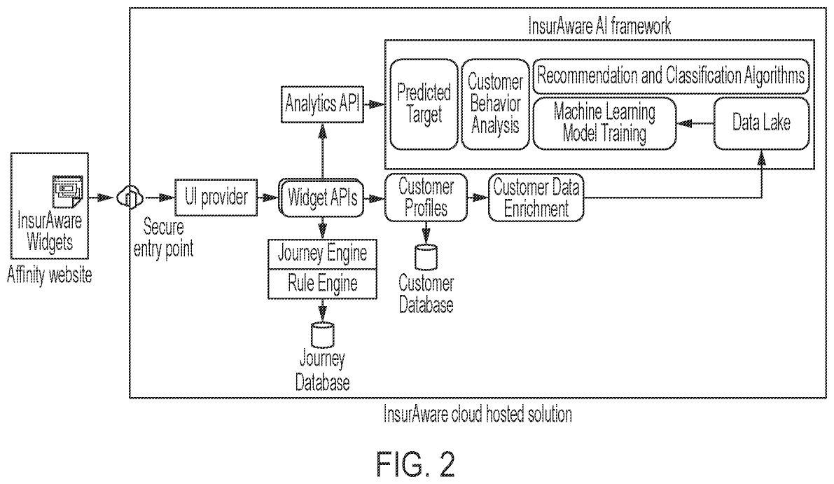

FIG. 2 is a diagram illustrating an architecture of a widget hosted on an affiliate site for developing targeting advertising to potential customers of consumer financial products as described by the disclosed embodiments. FIG. 2 is not intended to be an exhaustive or limited example of an architecture of a widget hosted on an affiliate site for developing targeting advertising to potential customers of consumer financial products to the form disclosed. The diagram was chosen to explain the principles of a method for developing targeting advertising and the practical application and to enable others of ordinary skill in the art to understand the disclosure for various implementation(s) with various modifications and/or any combinations of implementation(s) as are suited to the particular use contemplated.

As the one shown in FIG. 2, when a user clicks on a widget, the widget establishes a secure connection with a host website cloud-hosted solution. An affiliate site is preregistered with the host website to allow an already-registered affiliate site to use the embodiments described herein. A security layer validates whether or not an affiliate site has been pre-registered with a host website and then creates the connection between the host website and the affiliate site following this verification. The host website platform asks questions to a user and then asks additional questions based on the user's reply for each question. A graph-based database and engine built on top of the database provides the intelligence for the reflexive questions. Users' responses are stored in the customer database, and this is used to train the system to help with the future recommendations. A user interface (UI) provider decides how to render the UI to an affiliate website based on what browser is used by the user to open the widget. Basic needs financial calculator application programming interfaces (APIs) are called by the UI provider to deliver questions to the user. An analytical API communicates with an AI framework to run a recommendation algorithm by providing the user inputs to the AI framework. The AI framework has a user behavior data storage that is used to create machine-learning models for the consumption of the recommendation engine. In some embodiments, user data from many users is stored and utilized to build larger machine-learning models. As models are built, they can be trained utilizing new data coming, which further improve the accuracy of the prediction for the user. The analytics API sends the recommended product information provided by the framework to the user.

As used herein, the term “consumer financial products” refers to products that provide financial protection to the consumer in case of an unforeseen life circumstance, such as insurance policies. Examples of insurance policies in the spirit of this disclosure, include, but are not limited to, life insurance, health insurance, dental insurance, auto insurance, homeowner/renters insurance, accidental death and dismemberment insurance, disability insurance, long-term care insurance, pet insurance, flood insurance and umbrella insurance. The aforementioned insurance policies are not particularly limited, and other insurance policies, as well as, other products that provide financial protection to a consumer, not explicitly listed will be apparent to those of skill in the art once they have reviewed this specification without departing from the scope and spirit of the invention.

As used herein, the terms “convert,” “converts,” “converting,” or “conversion” to “[a] consumer(s)” refers to the individual, to whom advertising is targeted to, purchasing the advertised consumer product.

As used herein, the terms “automated-,” “automated-generated,” “automated-written,” and the like refer to materials that contain targeted advertisements to an individual, such as articles, audio/visual content, phone calls, etc., that are not produced directly by humans. Examples of such materials in the spirit of this disclosure, include, but are not limited to, articles written by AI or an AI algorithm, audio/visual content generated by AI or an AI algorithm, and phone calls conducted by AI or an AI algorithm. The aforementioned “automated-generated,” and “automated-written,” materials are not particularly limited, and other “automated-generated/written” materials, not explicitly listed will be apparent to those of skill in the art once they have reviewed this specification without departing from the scope and spirit of the invention.

As used herein, the terms “manually-,” “manually generated,” “manually written,” and the like refer to materials that contain targeted advertisements to an individual, such as articles, audio/visual content, phone calls, etc., that are produced directly by humans. Examples of such materials in the spirit of this disclosure, include, but are not limited to, articles written by a human, audio/visual content generated by a human, and phone calls conducted by a human. The aforementioned “manually-generated,” and “manually-written,” materials are not particularly limited, and other “manually-generated/written” materials, not explicitly listed will be apparent to those of skill in the art once they have reviewed this specification without departing from the scope and spirit of the invention. For the purposes of the term “manually,” “manually generated,” and “manually written,” these terms can refer to inputs created outside of the systems and methods disclosed herein that are analyzed, interpreted, and incorporated into the systems and methods described herein, which can further be analyzed, interpreted, manipulated, extrapolated, or integrated into an AI-algorithm to provide the targeting disclosed herein.

As used herein, the term “enrich,” “enriched,” “enriching,” “enrichment,” and the like refer to a process of extracting insight on consumer behavior on gathered data associated with the particular user. For purposes of demonstration enriching may comprise generating a library of search data from many different users, utilizing machine learning algorithms to associate interests and internet searches into corresponding keywords, and matching an individual user's IP address, hashed email, or user tag with and search data with interests and keywords from the library to identify behavior patterns. This process can be repeated over many iterations and across many different users to generate a larger library, which help to refine the machine learning algorithms and provide more accurate association between internet searches and user's interests, behaviors, and likely consumption habits. The aforementioned enriching process is not particularly limited, and other enriching processes, not explicitly listed will be apparent to those of skill in the art once they have reviewed this specification without departing from the scope and spirit of the invention.

Detailed embodiments are disclosed herein; however, it should be understood that the enclosed embodiments are merely examples and that the systems and methods described below can be used in numerous forms. Thus, specific structural and functional details disclosed in this specification should not be construed as limiting but merely are a basis for the claims as a representation basis for teaching one of skill in the art how to use the invention with an appropriate structure and function. Moreover, the terms and phrases used are not intended to be limiting, but instead are intended to provide an understandable description of the invention. Accordingly, the description of the present invention is presented for purposes of illustration and description but is not intended to be exhaustive or limited to the embodiment of the invention herein disclosed. Many modifications and variations will be apparent to those of skill in the art once they have reviewed this specification without departing from the scope and spirit of the invention. The embodiment was chosen and described to explain the principles of the invention and the practical application, and to enable others of skill in the art to understand the invention for various embodiments with various modifications as are suited to the particular use contemplated. The terminology used herein is for the purpose of describing particular embodiments only and is not intended to limit the invention.

1. A system for targeted advertising to an individual user comprising:
one or more computer readable mediums comprising:
an affiliate site;
a host site;
a third-party data provider;
a host data store;
a host sales tool; and
an array of targeted advertisements.

2. The system of claim 1, wherein the affiliate site displays information to the individual user.

3. The system of claim 2, further comprising a tooling widget that exists on the affiliate site.

4. The system of claim 3, wherein the tooling widget is configured to communicate data associated with the individual user to the host site; the data comprising an identifier associated with the individual user and at least one selected from the group consisting of the individual user's IP address, hashed email, user agent, metadata, and any combination thereof.

5. The system of claim 3, wherein the tooling widget is configured to embed scripts to the host site.

6. The system of claim 1, wherein the host site is configured to register first-party user data.

7. The system of claim 1, wherein the data store is at least one selected from the group consisting of servers, cloud storage, and distributed storage locations.

8. The system of claim 1, wherein the system further comprises at least one artificial intelligence or artificial intelligence algorithm and said artificial intelligence or artificial intelligence algorithm is configured to display targeted advertising to the individual user, wherein the targeted advertising is determined using artificial intelligence or artificial intelligence algorithm.

9. A method for targeting advertising to an individual user, the method comprising:
providing one or more computer readable mediums, the one or more computer readable mediums comprising:
an affiliate site;
a host site;
a third-party data provider;
a data store;
a host sales tool; and
an array of targeted advertisements;
the individual user visiting the affiliate site;
generating an identifier associated with the individual user;
extracting information from the individual user and providing the extracted information to the host site;
registering the identifier and the extracted information as first-party data;
normalizing the first-party data into normalized first-party data;
providing the normalized first-party data to the data store;
providing the normalized first-party data to the third-party data provider;
enriching the normalized first-party data with the third-party data provider to generate enriched data;
providing the enriched data to the data store and storing the enriched data, wherein the enriched data is stored in and is accessed from a same location as the normalized first-party data via the identifier;
specifying at least one targeting rule in the host sales tool;
evaluating whether the at least one targeting rule has been satisfied; and
creating a targeted advertisement from the array of targeted advertisements and sending the targeted advertisement to the individual user when the at least one targeting rule has been satisfied.

10. The method of claim 9, wherein the targeted advertisement is selected from the group consisting of an email, an automated call, a manual call, an automated-written blog article, a manually-written blog article, automated-generated audio content, automated-generated video content, manually-generated audio content, manually-generated video content, and an automated-generated survey.

11. The method of claim 9, wherein the affiliate site comprises a tooling widget that is hosted on the host site; wherein the tooling widget generates the identifier associated with the individual user and extracts the information from the individual user and provides the extracted information to the host site.

12. The method of claim 11, wherein the extracted information from the individual user is selected from the group consisting of the individual user's IP address, hashed email, user agent, metadata, and any combination thereof.

13. The method of claim 9, wherein the enriched data comprises at least one selected from the group consisting of data segments, keywords directly searched by the individual user, websites visited by the individual user, keywords associated with websites visited by the individual user, a search history of the individual user, and any combination thereof.

14. The method of claim 9, wherein the at least one targeting rule comprises one or both of (a) an event-driven rule, wherein the event-driven rule is satisfied when an event associated with the event-driven rule occurs; and (b) a periodic rule, wherein the periodic rule is satisfied when an amount of time since a last targeted advertisement being sent to the individual user has elapsed.

15. The method of claim 9, further comprising a data enrichment step after sending the targeted advertisement to the user, wherein the data enrichment step comprises:
recording the identifier of the user;
recording the individual user's targeted advertisement interactions;
providing the identifier of the user and the user's target advertisement interactions to at least one machine learning algorithm on the host site;
enriching the user's target advertisement interactions; and
providing enriched user's target advertisement interactions to the data store and storing the enriched user's target advertisement interactions, wherein the enriched data is stored in and is accessed from the same location as the normalized first-party data via the identifier.

16. The method of claim 15, wherein the individual user's targeted advertisement interactions are selected from the group consisting of clicks, conversions, metadata associated with the individual user and the individual user's interaction with the targeted advertisement, and any combination thereof.
